(19) United States
(12) Patent Application Publication
(10) Pub. No.: US 2011/0151074 A1
(43) Pub. Date: Jun. 23, 2011

(54) Automated food preparation apparatus and method

(76) Inventors: Harvey Titen, Longwood, FL (US); Charles W. Brantley, Orlando, FL (US)

(21) Appl. No.: 12/926,852

(22) Filed: Dec. 13, 2010

Related U.S. Application Data
(60) Provisional application No. 61/287,424, filed on Dec. 17, 2009.

(51) Int. Cl. A47J 37/12; A47J 36/00; A23L 1/01

(52) U.S. Cl. 426/233; 99/404; 99/407; 99/408; 99/334

(57) ABSTRACT

An apparatus for cooking a food product has a housing having a refrigeration section and a cooking section therein. The refrigeration system has a plurality of separate conveyor belts located to store the food product thereon and to feed the food product from one conveyor belt to the next and into a food proportioning device which delivers the food into the cooking section and into the cooker where the food product is cooked and then delivered into a container.

This application claims the benefit of U.S. Provisional Application No. 61/287,424, filed Dec. 17, 2009.

### FIELD OF INVENTION

The present invention generally relates to preparing foods and in particular to storing, apportioning, cooking, and presenting a food product for consumption.

### BACKGROUND

Automated food preparation methods and systems are generally well known. As addressed in US Patent Application US 2008/0063769 for Sus et al, the efficient, consistent and safe preparation of food in restaurants, especially fast food restaurants is essential for a successful operation. Certain foods must be prepared and cooked under exacting conditions. Consistency in food preparation can vary as a result of many factors including mishandling because a person is engaged in multiple tasks, by way of example. Proper scheduling of food production during peak and non-peak periods can result in wasted food. Further, the labor cost can be a large portion of the total cost of the prepared food. Yet further, fast food restaurants must be able to effectively meet a variable customer demand that is time dependent and not subject to precise prediction. Health and safety are always present where food is prepared directly by a person. By reducing or minimizing human contact with food and food cooking equipment, health and safety concerns can also be reduced or minimized. It is well known that the frying of foods or cooking in a hot fluid, such as cooking oil, present a concern for health and safety.

It is acknowledged that a need exists for an automated, commercially suitable food dispensing, cooking and packaging device, system and method for fried foods that can be operated with a minimum of human intervention, control and maintenance. More particularly, a need exists for an automated device, system and method that is capable of, without human labor, frying various food products in desired quantities, such as French fries, seasoning the cooked food and packaging the cooked food in individual portion-sized containers.

In an effort to satisfy these needs, US 2008/0063769 published application to Sus et al. discloses an automated food dispensing, frying and packaging device having a freezer compartment. In one embodiment, the structure for dispensing a predetermined quantity of food includes a vibratory conveyor typically located in the freezer below the storage container. The structure for dispensing may further include a device for determining or sensing a quantity of food that has been deposited in the secondary container and structure is provided for terminating the operation of the structure for dispensing when a predetermined quantity of food is sensed in the secondary container. The method includes weighing the food in the chute before dispensing the food to the container. A regulating device limits the quantity of French fries or other food that is delivered to conveyor so that conveyor does not get overloaded or jammed with food items.

By way of further example, French patent publication, FR 2597319 to Dreyer discloses an automatic fried food product preparer and dispenser with freezer in its upper part containing a dispensing hopper for storage of food products such as chips. The chips are fed via an endless screw to a balance. Under the balance is a receptacle closed by a motorized trap communicates with the interior of a deep fat fryer. Yet further, U.S. Pat. No. 5,404,796 to Campbell et al. discloses a vending machine for providing French fries from a powdered potato mix. Uncooked French fry strips fall onto a mesh net in the cooking chamber that sags into the oil to allow cooking. After the fries are fully cooked tension is applied to the mesh net that is then pulled back up out of the oil.

In spite of the efforts to date to meet these needs, there remains a need for preparing a cooked fast food styled product in an efficient and clean manner, and with consistency regardless of the experience of the server. In particular, there is a need to provide a preselected portion of the food product for sale with consistency and accuracy to a customer. There is also a need to be able to store the food product in a frozen state and conveniently located for efficiently delivering the food product to a cooker and subsequently to a customer in a timely manner.

### SUMMARY

The present invention is directed to the storing, apportioning, cooking, and delivering a food product, such as French fries, in an efficient manner. One embodiment may be described as comprising a freezer-storage area and a cooking area. Embodiments of the invention may further comprise a self contained apparatus including a prepared, yet precooked storage area. The storage area may include a conveyor for delivering the precooked food to a food apportionment area. Both the food storage and apportionment area may be within a housing portion for maintaining the food at a predetermined temperature. The predetermined temperature may be a temperature for preserving the food, such as a freezing temperature. One embodiment may comprise a “desk top” styled cooker which may be described as including a freezer storage and apportioning area, a transport isolation mechanism, a cooker (such as a fryer), and a cooked food delivery system. The transport isolation mechanism provides a thermal barrier in cooperation with a barrier wall separating the food storage area from cooking and delivery areas, and also provides an isolation to assure that there is no opportunity for contamination.

One embodiment of the invention may comprise a “table top” styled self contained storage and cooking processor. The food processor will deliver a finished product, ready for consumption. As above described, the product may be stored at a freezing temperature to maintain quality and long term storage. On demand, the food product may be cooked (in a low cholesterol vegetable oil, by way of example) and delivered (French fries may take 40 seconds, by way of example) into a delivery tray. The product may be weighed prior to cooking for assuring a correct portion control. The product may be stored in a frozen environment until required for the cooking process, and may be stored at a frozen temperature or in a temperature exceeding 200 F for cooking, by way of example for potatoes, assuring no opportunity for contamination, thus resulting in FDA reviewer satisfaction.

Embodiments of the invention provide a sterile environment that contains a total (but not limited to) of 60 large orders of product. The conveyor storage assembly, during the process of handling the food product, organizes the food, such as French fries, to provide accurate portion control. The portion amount is pre-selected within the machine, by weight selection. In all cases, the contaminant-free handling of the product is paramount. The portion selected is delivered through an isolated trough assembly. The trough assembly isolates and maintains the contaminant-free environment of the machine and delivers the product to the cooking system.

Further to method and apparatus embodiments of the invention, a cooking oil formula is engineered to lower cholesterol and calorie count. The product is then delivered directly to a contaminant-free, lined-plastic cardboard tray. Upon delivery of the product to the tray/cup assembly, a safety door is then released to open, allowing the product to be retrieved by the customer. The storage system may be a hard-frozen compartment, maintaining the internal temperature of no higher than approximately 7-14 degrees F.

Yet further to the teachings of the present invention, a pre-selected potato product may include a total of 54 different potato products, from which two varieties are pre-selected for consistency of taste, texture, color and reaction to the cooking process. This particular selection meets desirable specifications for taste and consistency. Packages may be provided in a 6 lb sealed bag, that can be taken directly to the apparatus, tearing the bag open and dropping directly into the storage compartment, without touching by human hands. The cooking oil mixture was likewise selected from a wide variety of available mixtures, formulated to desirable specifications which likewise maintain the taste, texture and consistency of the product. This mixture maintains the specifications for the product.

With regard to embodiments of the invention, a safety interlock on the door prevents premature access to the delivery compartment until such time as the product is completely cooked, eliminating injury from people prematurely trying to enter the compartment with their hands/fingers. A filtered air flow system may be used to remove the vapor generated by the cooking process, and filter any outside contaminants from entering the cooking compartment. Additionally, the filtering system eliminates any possibility of any product or cooking oil from reaching a potential flashpoint that might cause injury.

By way of example with regard to a method aspect of the invention, cooking time from the dropping of the product load into the cooking compartment until delivery to the customer is approximately 40 seconds. As a potato product to be used is specified, the cooking oil formula to be used, the environments of the storage and cooking compartments that must be maintained, provide conditions to be maintained, and the apparatus automatically maintains such specifications. This adherence to the conditions include the purchase of supplies (potato and oil formula), and the use of the appropriate supply voltage. Support of the embodiment of the invention may therefore be continued by a provider as long as these conditions are met.

By way of further example, to enhance a control of portion size, it is desirable that the cut potatoes be aligned crossways to the conveyor belt at the time they are dropped into the scale assembly. When the potatoes are initially dropped onto the top level of the conveyor assembly, they will typically not be properly aligned at this point. As they reach the end of the first conveyor belt, any cut potatoes that are not aligned crossways to the belt, are turned by hitting the end of the area prior to falling down to the next level. After going through this process twice, they are all aligned crossways to the belt, and therefore ready to be dropped into the scale with proper alignment. This permits much more accurate portion control than would otherwise be the case.

### BRIEF DESCRIPTION OF THE DRAWINGS

Other objects, features, and advantages of the present invention will be apparent from the written description and the drawings in which:

FIG. 1 is a perspective view of an apparatus for cooking a food product in accordance with the present invention;

FIG. 2 is a rear sectional view taken through the apparatus of FIG. 1;

FIG. 3 is front sectional view of the apparatus of FIGS. 1 and 2; and

FIG. 4 is a side sectional view of the apparatus of FIGS. 1-3.

### DETAILED DESCRIPTION OF THE PREFERRED EMBODIMENT

The present invention is herein more fully described with reference to the accompanying drawing in which alternate embodiments of the invention are shown and described. It is to be understood that the invention may be embodied in many different forms and not to be construed as limited to the illustrated embodiment set forth herein.

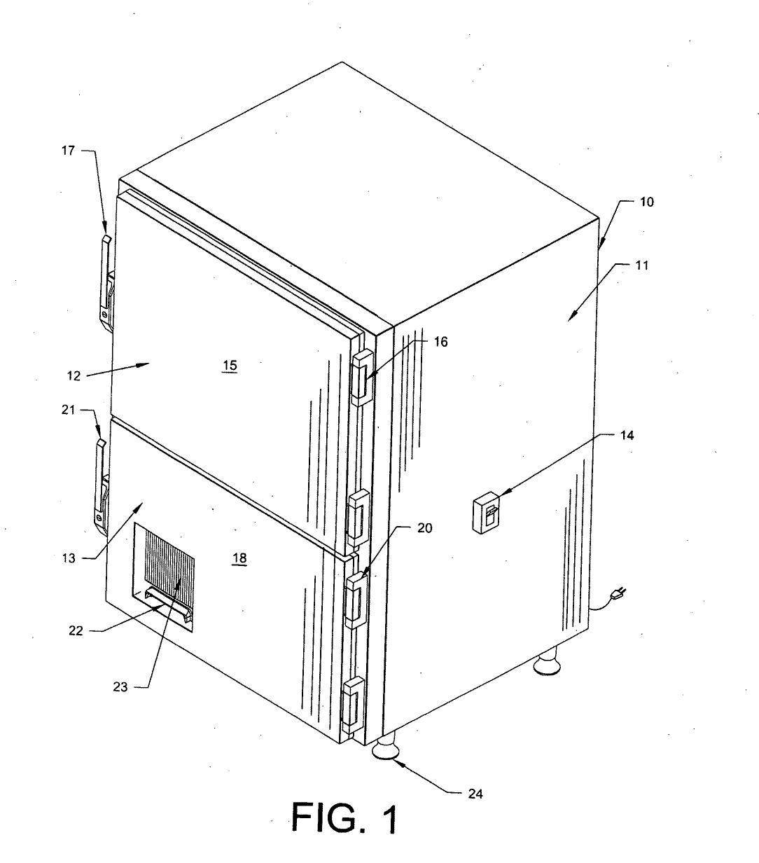

In FIG. 1 of the drawings, an apparatus 10 for cooking food products, such as french fried potatoes, is illustrated and has a housing 11 having a freezer section 12 located over a delivery and cooking section 13. The apparatus has the power switch 14 for activating the apparatus. The freezer section has an access door 15 having hinges 16 and a handle 17 whereas the delivery and cooking section 13 has an access door 18 having hinges 20 and a handle 21. A cooked food delivery area 22 has a vented door 23 located in the door 18. The apparatus 10 has a plurality of legs 24.

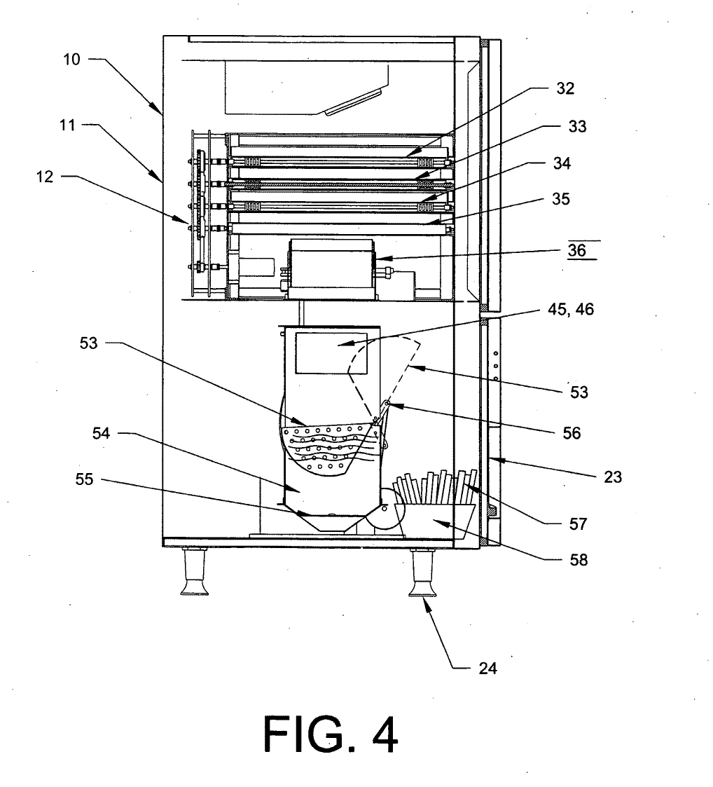

Turning to FIGS. 1 and 4, the operation of the apparatus 10 for cooking a food product is illustrated in which the housing 11 has the freezer section 12 having a food product loading area 30 or hopper for loading frozen foods, such as french fries, onto the storage and delivery belts. The loading area 30 is dispensing from a door in the top of the freezer for dispensing the food product onto a first conveyor belt 32 which is the first food storage and separation conveyor belt. The conveyor belts both separate and store the frozen foods. The frozen food is first dropped onto conveyor belt 32 which stores the food product thereon ready for the next delivery to the next conveyor belt 33 when the conveyor belts are activated. When the conveyor belt 32 is activated it delivers the frozen food product onto the second conveyor belt 33 which stores additional food product, such as french fries, as the conveyor belts move simultaneously. The food product on conveyor belt 33 is delivered onto conveyor belt 34 which delivers frozen food product onto the fourth or last conveyor belt 35. At this point, the frozen food, such as french fries, has been separated and stored on the conveyor belts and along the conveyor belts while still frozen.

The food product is delivered from the last conveyor belt 35 onto a scale or food portioning assembly 36 which has a fulcrum arm 37 having a balancing arm 38 supported on a hinge pin 40. The arm 38 has a counterweight 41 on the end thereof which holds the arm 38 in position with the tray 42 pinned with a pin 43 on the other end of the arm 38. The food in tray 42 is held therein by a door 44 until the conveyor belt 35 has dumped the frozen food product onto the tray 42. The food product in the tray 42 will reach a point where the arm 38 tilts by offsetting the counter-balancing weight 41. When the tray 42 tilts, the door 44 is withdrawn by the activation of the motor 46 to pull an arm 48 to dump the food product from the freezer section 12 into the cooking section 13.

The food product is dumped into a receptacle or receiving area 45 in a paddle 47 delivery system. The paddle 47 is driven by the motor 46 which drives an arm 48 which is pinned off-center to a paddle drive 50 in a crank mechanism. One rotation of the paddle drive 50 pushes the arm 48 to push the paddle 47 to drive the product deposited in front of the paddle assembly into the cooker 51. A photocell 52 in the freezer section 12 senses the movement of the tray 42 moving to dump the food portion into the cooking section 13 and turns off the movement of all the conveyor belts simultaneously so that the conveyor belts quit delivering food as soon as the tray 42 drops a food portion therefrom.

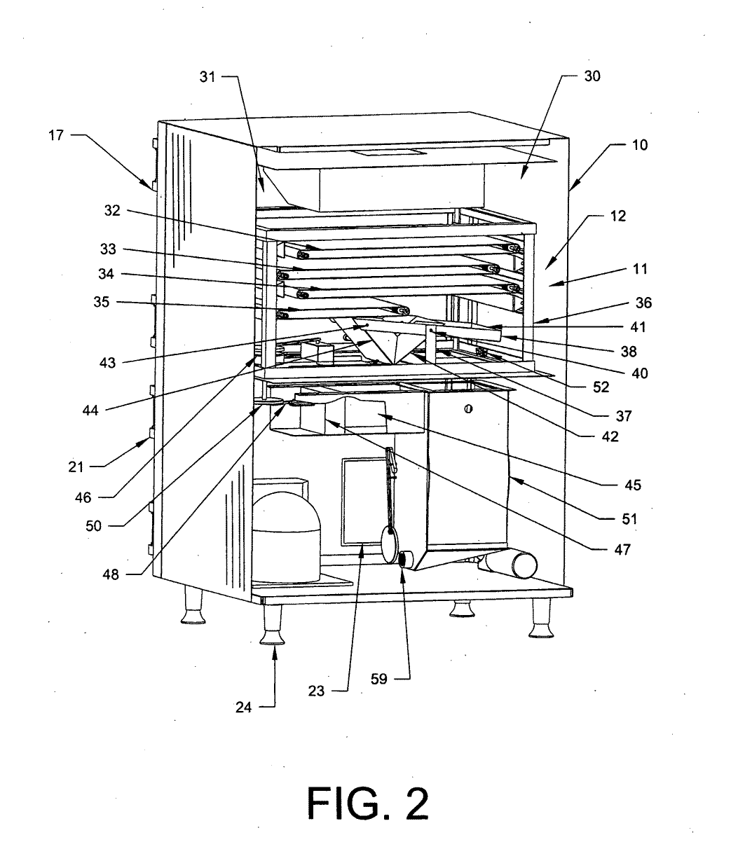

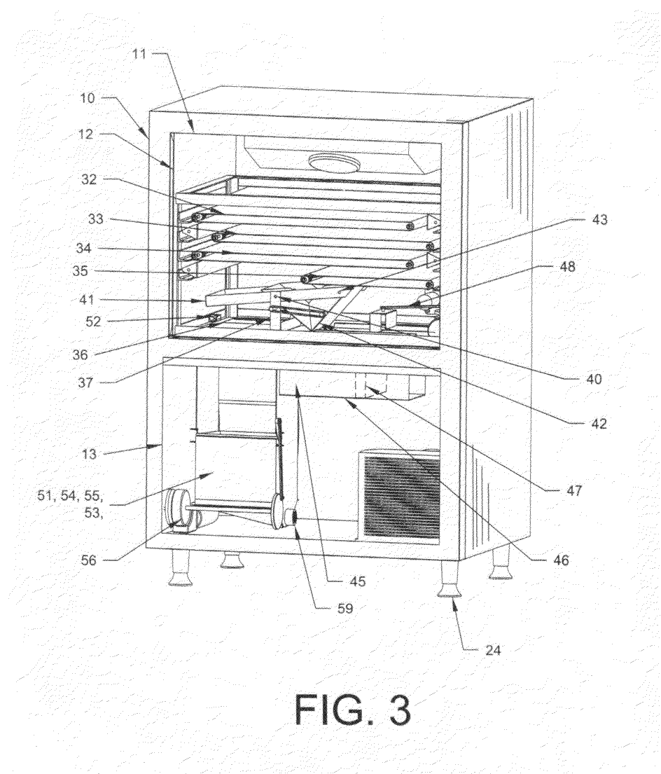

The cooker 51 is typically filled with cooking oil, as more clearly seen in FIG. 4. The cooker has a cooking screen basket 53, as shown in FIG. 4. The cooking oil 54 is heated by a heating element 55. The food is cooked for a predetermined time period in the heated cooking oil 54 at which time an electric basket drive 56 lifts the screen basket 53 to dump the food products, such as french fries 57, into a paper container 58. The cooking container, as seen in FIGS. 2 and 3, has a drain 59 for draining the oil when the oil needs draining. The cooked food product is delivered from the cooker 51 into the container 58 located within the dispensing area 23 which has a door 22 which has an interlock to prevent the door being opened prematurely.

The apparatus for cooking the food product has the food contacting components being primarily of stainless steel while the conveyor belts 32, 33, 34, and 35 may be mesh conveyor belts of a reinforced polymer for transporting the frozen food. An opening of about 2 inches at the end of each belt allows food product to drop from one conveyor belt to the next. The last conveyor belt then drops the product onto the scale or measuring or proportioning device 36 where a predetermined portion is delivered from the freezer section 12 into the cooking section 13. The dumping of the food product is sensed by a sensor 52 to turn off the conveyor belts from delivery of any more frozen food product. The electric sensor 52 senses the power and stops the feed conveyor belt from delivering further food product. Frozen food is left on the conveyor belts awaiting activation of the belts for delivery into the cooking section 13. A trough door is used to isolate the cooker's heat from the freezer section. Insulation may be placed between the freezer and cooking sections. The paddle retracts to allow delivery of the food product to an area in the paddle assembly to maintain the isolation of the freezer section from the cooking section. The paddle, after moving the food product into the cooker, then returns to a static location and stops until the sensor senses the operation of the weighing assembly delivering additional food product thereto. The cooker 51 cooks the product, such as french fries, for a selected time, assuring consistency of the finished product.

The cooking screen basket 53 conveys the cooked product in the cooker into the receiving tray 58 by activating the basket lifting mechanism 56 driven by an electric motor. The screen basket drive 53 rotates the screen basket 53 to dispense the product from the cooking oil 54 to drop the cooked food into a delivery tray 50 or a container under the force of gravity. The cooking basket 53 is then released and allowed to fall back into the cooking oil. A power cord 60 is plugged into an electric power source to power the operation of the apparatus.

In operation, the freezer is brought up to a proper temperature and the frozen food is loaded into the freezer compartment. Once the conveyor switch is activated, the conveyor belts begin running until approximately four ounces of frozen potatoes has reached the end of the bottom conveyor belt and moved onto the tray portion of the food storage scale. When the scale shelf moves downward to drop the frozen potatoes, a photocell activates the stop condition which stops the conveyor belts from further movement and places the conveyor belts in a stand-by condition. Lifting the access door of the front panel can start the next phase by inserting a container into the receiving area and the doors lowered to its original position. The door is monitored by a photocell.

In operation, the access door is raised to insert a container. The lowering of the door will start producing a load of french fries. The frozen french fries are delivered to the paddle assembly when the appropriate load of frozen potatoes has been reached on the scale and the load then dropped into the paddle assembly. The paddle also serves to isolate the freezer compartment from the cooker compartment and slides back to permit the load of potatoes to drop into the trough. Once in the trough, the paddle moves back to its original position thereby isolating the two compartments and at the same time dropping the potatoes down into the cooker which has a basket or screen ready to receive the load of potatoes. The paddle retreats to its original position as does the scale tray which has dumped the fries into the cooker to return to its upward position awaiting a new load which automatically starts the conveyor belts to position still another load onto the scale tray for the next operation. Upon completion of the cooking cycle, the motor drive at the bottom of the cooker is connected to a crank mechanism to cause the arm connected to the basket to lift or rotate the basket to a preselected angle for dumping the cooked food into the waiting container. The freezer storage assembly receives and stores the frozen sliced potato product for dumping them onto the conveyor belts where they are separated and stored in the freezer compartment on the conveyor belts ready to be moved from one belt to the next and dumped onto the weighing scale. The freezer storage compartment can be maintained at a temperature of approximately 7° F.

The method of cooking and dispensing french fries may include the steps of selecting a french fries cooking apparatus with a housing having a refrigeration section holding frozen french fries therein and having a cooking section therein. The refrigeration section contains the frozen potato product which has a plurality of separate conveyor belts located in the housing and delivers the food product to a metering system positioned below the conveyor belts but within the freezer section where it is dumped into a delivery system within the cooking section. The frozen food product is dispensed from the plurality of conveyor belts as its moves from a first conveyor belt to the next conveyor belt and onto the last conveyor belt and then onto a weighing tray. The weighing tray dispenses a weighed portion of frozen potatoes from the weighed scale surface into the cooking section. A paddle mechanism pushes the frozen potatoes into a cooking container of oil where it is cooked for a predetermined period of time. The cooked french fries are then dispensed from the cooking container.

It should be clear at this time that an apparatus and method for cooking food products and especially for cooking potatoes to make french fried potatoes in a predetermined portion has been provided which advantageously may be placed within a retail establishment for delivery of freshly cooked french fried potatoes or the like to a customer on demand. However, the present system is not to be construed as limited to the forms shown which are to be considered illustrative rather than restrictive.

We claim:

1. An apparatus for cooking food products comprising:
a housing;
a refrigeration section located in said housing and adapted to hold frozen food products therein;
a cooking section positioned in said, housing for cooking frozen food products therein and separated from said refrigeration section;
a plurality of separate conveyor belts located in said refrigeration section, the first said conveyor belt being positioned beneath a food product loading area for receiving food product thereon and conveying said food product to the next adjacent conveyor belt, the last of said plurality of conveyor belts being adapted to receive food product from an adjacent conveyor belt and delivering food product therefrom;
a food product metering system positioned below said plurality of conveyor belts in said refrigeration section for receiving food product from said last conveyor belt and delivering a measured amount of food product therefrom;
a food product holding area located in said cooking section for receiving food product from said metering system in said refrigeration section and dispensing said measured amount of food product therefrom;
a cooking container for receiving said measured amount of food product from said food product holding area and cooking the received food product; and
dispensing means for dispensing said cooked food product from said housing;
whereby a frozen food product may be cooked in said apparatus for cooking a food product and dispensed therefrom.

2. The apparatus for cooking a food product in accordance with claim 1 in which said plurality of conveyor belts includes four separate conveyor belts separating and delivering frozen food product to the cooking section.

3. The apparatus for cooking a food product in accordance with claim 2 in which said cooking section cooking container is partially filled with cooking oil.

4. The apparatus for cooking a food product in accordance with claim 3 in which said cooking container has an electric heating element therein.

5. The apparatus for cooking a food product in accordance with claim 4 in which said cooking container has a screen basket therein for supporting food product in said cooking oil while said food product is being cooked.

6. The apparatus for cooking a food product in accordance with claim 5 in which said screen basket in said cooking container includes a mechanism for lifting said screen basket and cooked food product therein and dispensing said cooked food product into a container in a housing dispensing compartment.

7. The apparatus for cooking a food product in accordance with claim 6 in which said housing dispensing compartment has a door having a safety interlock to prevent premature access thereinto.

8. The apparatus for cooking a food product in accordance with claim 7 in which said food product metering system has a sensor to sense when a predetermined amount of food product has been dispensed which sensor stops the movement of said plurality of conveyor belts.

9. The apparatus for cooking a food product in accordance with claim 1 in which said food product measuring system includes a counter-weighted tray having a tray supported on one end of a hinged arm and having a counter-weight on the other end of the hinged arm, said counter-weight being selected to allow the tray to tilt and dump food product therein upon said tray receiving a predetermined amount of food product from said last conveyor belt.

10. The apparatus for cooking a food product in accordance with claim 9 in which said food product holder in said cooking section includes a paddle driven by an pushing arm eccentrically pinned to a rotating wheel.

11. A method of cooking and dispensing french fries comprising the steps of:
selecting a french fries cooking apparatus having a housing having a refrigeration section for storing frozen potatoes therein and having a cooking section in said housing, said french fries cooking apparatus freezer section having a plurality of separate conveyor belts located therein and having a weighing scale positioned below said plurality of conveyor belts, said cooking section having a potato holding trough therein below said weighing scale for holding and dispensing said potatoes therein into a cooking container and dispensing means for dispensing cooked french fries from said housing;
loading frozen potatoes onto the first of said plurality of conveyor belts in said refrigeration unit;
moving said frozen potatoes from the first conveyor belt to the next adjacent conveyor belt;
moving the frozen potatoes from the last of said plurality of conveyor belts onto said weighing scale;
dispensing a weighted portion of frozen potatoes from said weighing scale into said cooking unit into a holding trough;
pushing said weighted frozen potatoes into a cooking container of oil;
cooking said frozen potatoes; and
dispensing cooked french fried potatoes from said cooking container;
whereby a preselected portion of frozen french fries are cooked and dispensed.

12. The method of cooking and dispensing french fries in accordance with claim 11 in which said potatoes deposited on said first conveyor belt are dispensed onto a second conveyor belt and from said second conveyor belt onto a third conveyor belt and from said third conveyor belt to a last conveyor belt and from said last conveyor belt onto said weighing scale.
